(19) United States
(12) Patent Application Publication
(10) Pub. No.: US 2005/0035036 A1
(43) Pub. Date: Feb. 17, 2005

(54) Water-purification jug, for domestic use

(76) Inventor: Leonida Moretto, Vicenza (IT)

Correspondence Address: MERCHANT & GOULD PC, P.O. BOX 2903, MINNEAPOLIS, MN, 55402-0903, US

(21) Appl. No.: 10/491,513

(22) PCT Filed: Aug. 22, 2002
(86) PCT No.: PCT/IT02/00548

(30) Foreign Application Priority Data
Oct. 2, 2001 (IT) PD01A000234

(51) Int. Cl. B01D 35/14

(52) U.S. Cl. 210/87; 210/94; 210/474; 210/475

(57) ABSTRACT

A filter jug for purifying water for domestic use comprises a container (2) divided at least into a first compartment (8) and a second compartment (9) intercommunicating through a filter cartridge (11), and a first duct (12) and a second duct (13) for the admission and for the discharge of the water to the first compartment and from the second compartment (8, 9), respectively. Flow-measuring means (15) and counting means (14, 14a, 14b), associated therewith, are provided in the jug in at least one of the ducts (12, 13), for determining the total quantity of water treated by the filter cartridge (11) so as to identify the reaching of a limit quantity above which the cartridge should be considered exhausted.

### TECHNICAL FIELD

The present invention relates to a filter jug for purifying water, for domestic use, according to the preamble to the main claim.

### TECHNOLOGICAL BACKGROUND

Filter jugs of the above-mentioned type generally have filter cartridges which purify the water admitted to the jug, for example, by adsorption on activated carbon. However, these cartridges are subject to exhaustion of their filtering capacity and they therefore have to be replaced after a predetermined period of use or after they have treated a predetermined limit quantity of water.

Within the technical field to which the invention relates, a need has therefore emerged to provide suitable systems which can indicate to the user the moment at which it is necessary to replace the exhausted cartridge.

It is known, for example, from the Applicants international patent application No. PCT/EP95/04231 to provide, on the jug, counting means, associated with a removable lid of the jug, for counting the number of lid-opening and closure cycles. The amount of water treated by the filter cartridge is deduced indirectly from this count, upon the assumption that the jug is filled upon each opening and subsequent closure of the lid.

This measurement clearly lacks reliability since it is in no way correlated with a direct measurement of the amount of water admitted to the jug.

It is also known to incorporate in the filter cartridge means which are sensitive to the flow or to the presence of water and which can indicate that the cartridge is exhausted as a result of a structural change of an element of the means, resulting from prolonged contact with water. Since these means are incorporated in the cartridge, they have to be replaced with the cartridge from time to time, which can lead to an excessive Increase in the price of the cartridge or, in order to limit costs, to the selection of low-quality systems with poor reliability, for example, of the ablation type.

### DESCRIPTION OF THE INVENTION

The problem underlying the present invention is to provide a filter jug which is devised structurally and functionally to overcome the limitations set forth above with reference to the prior art mentioned.

Within the scope of this problem, an object of the invention is to provide a jug in which the parameters of use of the cartridge are Indicated in a manner such as to permit an easy assessment of its useful life, also indicating the reaching of one of the maximum limits provided for the said parameters of use.

This problem is solved and this object is achieved by the present invention by means of a filter jug for purifying water, for domestic use, formed in accordance with the appended claims.

### BRIEF DESCRIPTION OF THE DRAWINGS

The characteristics and the advantages of the invention will become clearer from the detailed description of a preferred embodiment thereof, given by way of non-limiting example, with reference to the appended drawings, in which:

FIG. 1 is a schematic, side elevational and sectioned view of a filter jug formed in accordance with the present invention,

FIGS. 2, 3 and 4 are enlarged views of respective variants of a detail of FIG. 1, and

FIG. 5 is a view similar to FIG. 1 of a filter jug formed in accordance with a variant of the invention.

### PREFERRED EMBODIMENT OF THE INVENTION

In the drawings, a filter jug formed in accordance with the present invention is generally indicated 1.

The jug 1 comprises a container 2 in which a base 3 and a mouth 4, opening at the opposite end, are identified.

The mouth 4 of the container 2 is closed, except for a pouring spout 5, by a removable lid 6. A handle 7 is also fitted on the container 2, diametrally opposite the pouring spout 5.

The container 2 is divided into a first compartment 8 and a second compartment 9, separated from one another by a dividing wall 10 and intercommunicating through a filter cartridge 11 which is fitted removably in a seat extending through the dividing wall 10.

The first compartment 8 extends in the region of the mouth 4 of the container 2 and is closed by the lid 6 in which, however, a first duct 12, opening towards the exterior, is defined for the admission of water to the first compartment 8. The first duct 12 can preferably be closed by a plug or gate-valve element, not shown in the drawings. The second compartment 9 is defined in the base 3 of the container 2 and is in flow communication with the pouring spout 5 by means of a second duct 13 defined between the dividing wall 10 and the wall of the container 2, for the discharge of the water from the second compartment 9.

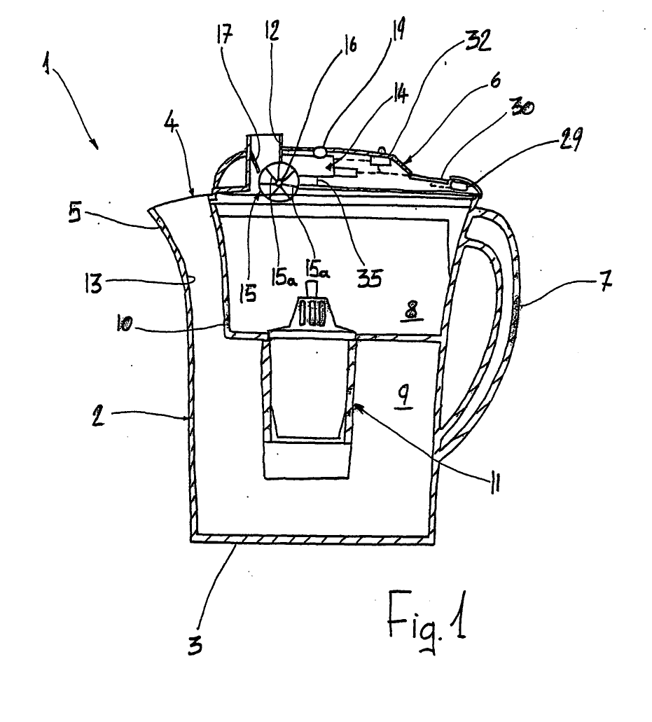

With reference to FIG. 1, the jug 1 comprises means for measuring the flow of water admitted to the first compartment 8 through the first duct 12 and means 14 for counting the total amount of water measured by the measuring means.

The measuring means comprise a turbine wheel 15 which projects into the first duct 12 and can rotate about a shaft 16 as a result of the flow of water through the first duct 12.

For this purpose, the turbine wheel 15 comprises blades 15a extending radially across the cross-section of the first duct 12 so as to be struck by the water admitted along it. Preferably, the first duct 12 is shaped in a manner such as to convey the entire flow of water towards the turbine wheel 15 by means of a guide 17.

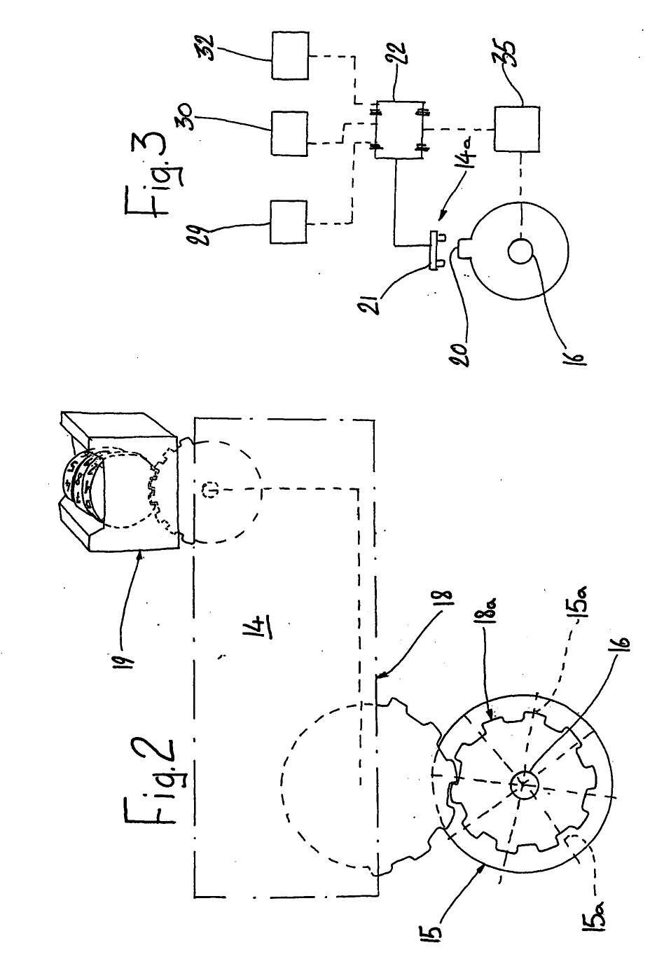

The shaft 16 extends transverse the direction of flow of the water and serves to transmit the rotational movement to the counting means 14 which are provided for detecting and adding up the number of revolutions performed by the turbine wheel 15. In a first variant of the invention (FIG. 2), the counting means 14 are mechanical and comprise a system of gears 18 kinematically connected to a toothed wheel 18a mounted firmly on the shaft 16 at the end remote from the turbine wheel 15. The system of gears, which is shown schematically and partially in FIG. 2, is operatively connected to a drum counter 19 on which the amount of water which has passed through the first duct 12 is shown in figures. The dimensions and calibration of the system of gears 18 are such as to convert the number of revolutions of the turbine wheel 15 into the corresponding amount of water, expressed in suitable units of measurement, for example, in litres.

It is envisaged that, instead of being mechanical, the counting means may be optoelectrical means, generally indicated 14a in FIG. 3, or electromechanical means, generally indicated 14b in FIG. 4, or even electronic means, not shown.

In the first case, an optical indicator 20, for example, of the cam type, is keyed to the shaft 16 and associated with a fixed optical detector 21 located in the vicinity of the shaft 16 and capable of transmitting an electrical pulse each time the optical indicator 20 passes in front of it. The electrical pulses transmitted by the optical detector 21 are collected, processed and stored by a control unit 22. It will be noted that, in this case, there is no contact between the measuring members (in movement) and the detection members (fixed), thus preventing the problems of wear of mechanical devices.

In the second case, the number of revolutions performed by the turbine wheel 15 is detected by interaction between a cam 25 fixed for rotation with the shaft 16 and an appendage 26 connected to an electrical switch 27. Upon each passage of the cam 25, the appendage 26 is moved from its rest position (shown by a continuous line in FIG. 4), operating the switch 27 and thus transmitting an electrical pulse to a control unit 28 functionally similar to the control unit 22 of the counter means 14a.

As a further alternative, it is possible to use flow-measurement means and/or entirely electronic counting means, for example, of the capacitive type or of other known types.

In view of the fact that the useful life of the filter cartridge 11 depends not only on the total quantity of water treated but also on the period of use, time-measurement means, for example, including a chronometer 29, are advantageously provided on the jug 1.

The jug 1 also comprises indicator means which can display the amount of water added up by the counting means 14 and/or the time measured by the chronometer 29. These indicator means comprise a liquid-crystal display 30 associated with the chronometer 29 and, if the counting means are mechanical, the drum counter 19.

If the jug is provided with one of the counting means 14a, 14b described above with reference to FIGS. 3 and 4, all of the data can advantageously be displayed on the display 30.

To facilitate reading of the parameters of use of the filter cartridge 11, the indicator means are preferably of the “countdown” type, displaying the amount of water which can actually still be filtered and/or the remaining life of the cartridge 11. The indicator means also include devices for setting or resetting both the limit quantity of water which can be treated by the cartridge 11 and its maximum period of use.

Signalling means 32 are also connected to the indicator means (or to the counting means by means of the control unit 22, 28) for signalling the exhaustion of the filtering capacity of the cartridge 11, reminding the user to replace it.

This event is determined by the reaching of the preset limit quantity of water treated or by the reaching of the maximum period of use.

The signalling means 32 may be acoustic (for example, a “beeper”), or optical (for example, an indicator lamp).

The jug 1 is also equipped with locking means 35 which can lock the turbine wheel 15 when one of the limit quantity of water treated by the cartridge 11 and its maximum period of use has been reached.

The locking means are operatively connected to the indicator means or to the counting means (for example, to the control unit 22 or 28 of the counting means 14a, 14b) and are combined with the signalling means 32 to deter the user from using the filter cartridge 11 once it is exhausted. In fact, it will be noted that the locking of the turbine wheel 15 leads to at least partial obstruction of the first duct 12, in fact preventing the admission of water to the first compartment 8.

The operation of the jug 1 in normal conditions of use is described briefly below. The water is admitted to the first compartment 8 of the container 2 through the first duct 12. The turbine wheel 15 is rotated by the flow of water through the duct, and also by virtue of the conveying effect of the guide 17. The counting means, provided in one of the embodiments described above, are thus activated, so as to add up the revolutions performed by the turbine wheel 15, correlating them with a measurement of the total amount of water which has passed through the first duct 12.

The water admitted to the first compartment 8 then passes into the second compartment 9 through the filter cartridge 11, which purifies it. Once the water is in the second compartment 9, it is ready to be poured out through the second duct 13 and the pouring spout 5.

When the amount of water added up by the counting means, or the period of use measured by the chronometer 29, reaches the respective maximum limit, the signalling means are activated to warn the user of the need to replace the cartridge 11 and, at the same time, the rotation of the turbine wheel 15 is locked by the locking means 35 to obstruct the first duct 12.

The filter cartridge 11 is replaced in conventional manner by removing the lid, extracting the exhausted cartridge and fitting the new cartridge. After the lid 6 has been closed again, the counting means are zeroed and reset.

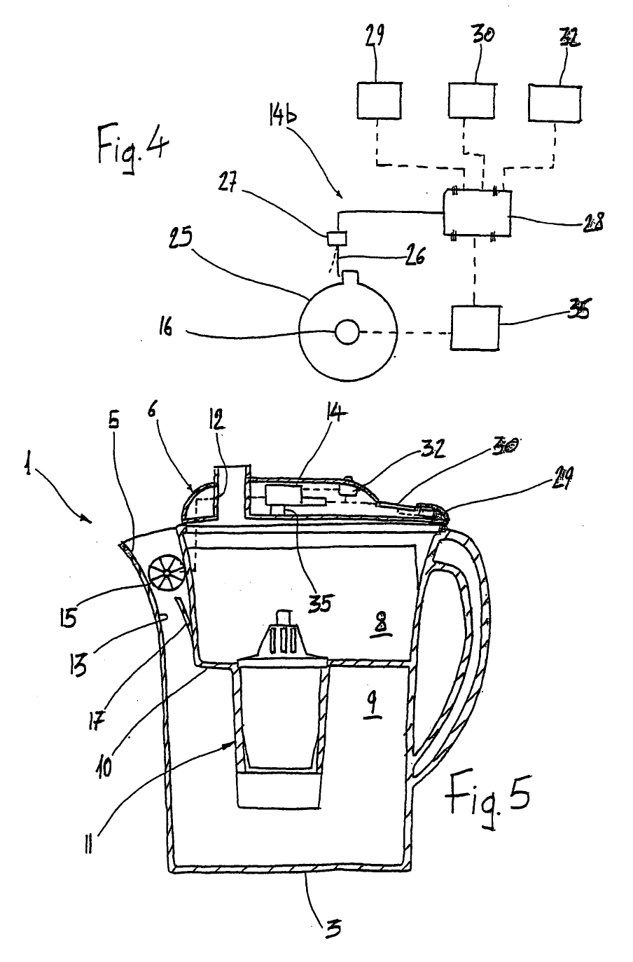

FIG. 5 shows a variant of the jug 1 which differs substantially in that the turbine wheel 15 is located in the second duct 13 rather than in the first duct 12. The measurement of the flow of water treated by the filter cartridge is thus performed when the water is discharged from the second compartment 9.

The present invention thus solves the problem discussed above with reference to the prior art mentioned, at the same time offering many further advantages, amongst which is the fact that the measurement performed is directly correlated with the quantity of water treated by the filter cartridge. Moreover, none of the means described above and required for the determination of the parameters of use of the cartridge (measuring means, counting means, indicating means, signalling means, locking means) is incorporated in the cartridge. They do not therefore have to be replaced periodically and the cost of the cartridge is not changed.

1. A filter jug for purifying water for domestic use, comprising a lid (6) and a container (2) divided at least into a first compartment (8) and a second compartment (9) intercommunicating through a filter cartridge (11) which is susceptible to exhaustion at least when a predetermined limit quantity of water treated has been reached, and a first duct (12) and a second duct (13) for the admission and for the discharge of the water into the first compartment and from the second compartment (8, 9), respectively, wherein said first (12) and second (13) duct are realized in said container (2) and/or in said lid (6) and that it comprises, in at least one of the ducts (12, 13), flow-measuring means (15) and counting means (14; 14a; 14b), associated with the measuring means (15) for determining the total amount of water treated by the filter cartridge (11) so as to identify the reaching of the limit quantity.

2. A jug according to claim 1 in which the measuring means comprise a turbine wheel (15) which can rotate as a result of the flow of liquid through the duct (12), the counting means being arranged to count the rotations of the turbine wheel (15) over time.

3. A jug according to claim 2 in which the turbine wheel (15) is supported for rotation by a drive-transmission shaft (16) extending transverse the direction of flow of the liquid in the duct (12).

4. A jug according to claim 3 in which the counting means (14) are mechanical and comprise a system of gears (18) kinematically connected to the shaft (16).

5. A jug according to claim 3 in which the counting mans (14a) are optoelectrical and comprise at least one optical indicator (20) fixed for rotation with the shaft (16) and one optical detector (21) for detecting the number of revolutions of the at least one optical indicator (20).

6. A jug according to claim 3 in which the counting means are electromechanical (14b) or electronic.

7. A jug according to claim 1 in which the counting means (14; 14a; 14b) are operatively connected to indicator means (30; 19) for displaying the amount of water treated by the filter cartridge (11).

8. A jug according to claim 7 in which the indicator means (30; 19) are of the “countdown” type, arranged to display the remaining filtering capacity of the filter cartridge (11).

9. A jug according to claim 1 in which the counting means (14; 14a; 14b) or the indicator means (30; 19) are operatively connected to signaling means (32) which can be activated when the limit quantity is reached in order to signal the exhaustion of the filter cartridge (11).

10. A jug according to claim 1, arranged for the use of filter cartridges susceptible to exhaustion upon the reaching of a predetermined maximum period of use, time-measurement means (29) being provided in the jug for identifying the reaching of the maximum period of us.

11. A jug according to claim 10 in which the time-measurement means (29) are operatively connected to the indicator means in order to display the remaining useful life of the filter cartridge (11).

12. A jug according to claim 10 in which the signaling means (32) are operatively connected to the time measurement means (29) and can be activated upon the reaching of the first of the limit quantity and the maximum period of use.

13. A jug according to claim 1 in which means (35) for locking the turbine wheel (15) are provided and are arranged to lock the wheel when the limit quantity or the maximum period of use have been reached.
